(19) United States
(12) Patent Application Publication
(10) Pub. No.: US 2026/0326519 A1
(43) Pub. Date: Oct. 22, 2026

(54) PROACTIVE WINDOW TINTING FOR PASSENGER COMFORT

(71) Applicant: GM GLOBAL TECHNOLOGY OPERATIONS LLC, Detroit, MI (US)

(72) Inventors: Manoj Kumar Sharma, Troy, MI (US); Akilesh Rajavenkatanarayanan, Clinton Township, MI (US); Donald K. Grimm, Utica, MI (US); Julien P. Mourou, Bloomfield Hills, MI (US)

(73) Assignee: GM GLOBAL TECHNOLOGY OPERATIONS LLC, Detroit, MI (US)

(21) Appl. No.: 19/182,207

(22) Filed: Apr. 17, 2025

(51) Int. Cl. B60J 3/04; G02F 1/01

(52) U.S. Cl. CPC B60J 3/04; G02F 1/0121

(57) ABSTRACT

In exemplary embodiments, methods and systems are for controlling dimming of windows of a vehicle, including obtaining, via one or more sensors of the vehicle, sensor data pertaining to an activity of one or more passengers of the vehicle; determining, via a processor of the vehicle, an optimized tint level for the windows, based at least in part on the activity of the one or more passengers; and automatically tinting the windows based on the optimized tint level, in accordance with instructions provided by the processor.

### TECHNICAL FIELD

The technical field generally relates to vehicles, and more particularly to tinting of windows for vehicles.

### BACKGROUND

Certain vehicles today have windows with varying amounts of tint. In certain situations it may be desirable to adjust window tint for vehicle based on different factors.

Accordingly, it is desirable to provide improved methods and systems for controlling tinting of windows of vehicles.

### SUMMARY

In accordance with an exemplary embodiment, a method is provided for controlling dimming of windows of a vehicle, the method including obtaining, via one or more sensors of the vehicle, sensor data pertaining to an activity of one or more passengers of the vehicle; determining, via a processor of the vehicle, an optimized tint level for the windows, based at least in part on the activity of the one or more passengers; and automatically tinting the windows based on the optimized tint level, in accordance with instructions provided by the processor.

Also in an exemplary embodiment, the optimized tint level is automatically adjusted by the processor based at least in part on a specific type of the activity of the one or more passengers and whether or not sunlight is beneficial or detrimental to the specific type of activity.

Also in an exemplary embodiment, the sensor data further pertains to a location of the one or more passengers of the vehicle, including specific passenger seats occupied by the one or more passengers; and the determining of the optimized tint level is further based at least in part on the location of the one or more passengers, including the specific passenger seats occupied by the one or more passengers.

Also in an exemplary embodiment, the sensor data further pertains to an age of the one or more passengers of the vehicle, including whether the one or more passengers are categorized as infants, children, or adults; and the determining of the optimized tint level is further based at least in part on the age of the one or more passengers, including whether the one or more passengers are categorized as infants, children, or adults.

Also in an exemplary embodiment, the sensor data further pertains to an exposure level of sunlight through the windows on the one or more passengers; and the determining of the optimized tint level is further based at least in part on the exposure level of the sunlight through the windows on the one or more passengers.

Also in an exemplary embodiment, the method further includes obtaining, via a satellite-based navigation system of the vehicle, a geographic location of the vehicle; and obtaining a maximum tinting value based a regulatory limit associated with the geographic location; wherein the determining of the optimized tint level is further based at least in part on the maximum tinting value based on the regulatory limit.

Also in an exemplary embodiment, the sensor data further pertains to operational parameters as to movement of the vehicle; the method further includes determining, via the processor, based on the operational parameters, one or more maneuvers of the vehicle including a vehicle turn; and the determining of the optimized tint level is further based at least in part on the one more maneuvers including the vehicle turn.

Also in an exemplary embodiment, the method further includes determining, via the processor using the sensor data, when the vehicle is approaching a known location or situation in which enhanced visibility is required; and the determining of the optimized tint level further provides for reduced tinting via the processor when it is determined by the processor that the vehicle is approaching the known location or situation in which enhanced visibility is required.

In another exemplary embodiment, a system is provided for controlling dimming of windows of a vehicle, the system including one or more sensors of a vehicle and a processor. The one or more sensors are configured to obtain sensor data pertaining to an activity of one or more passengers of the vehicle. The processor is coupled to the one or more sensors, and is configured to at least facilitate determining an optimized tint level for the windows, based at least in part on the activity of the one or more passengers; and automatically tinting the windows based on the optimized tint level, in accordance with instructions provided by the processor.

Also in an exemplary embodiment, the processor is configured to automatically adjust the optimized tint level based at least in part on a specific type of the activity of the one or more passengers and whether or not sunlight is beneficial or detrimental to the specific type of activity.

Also in an exemplary embodiment, the sensor data further pertains to a location of the one or more passengers of the vehicle, including specific passenger seats occupied by the one or more passengers; and the processor is configured to determine the optimized tint level further based at least in part on the location of the one or more passengers, including the specific passenger seats occupied by the one or more passengers.

Also in an exemplary embodiment, the sensor data further pertains to an age of the one or more passengers of the vehicle, including whether the one or more passengers are categorized as infants, children, or adults; and the processor is configured to determine the optimized tint level further based at least in part on the age of the one or more passengers, including whether the one or more passengers are categorized as infants, children, or adults.

Also in an exemplary embodiment, the sensor data further pertains to an exposure level of sunlight through the windows on the one or more passengers; and the processor is configured to determine the optimized tint level further based at least in part on the exposure level of the sunlight through the windows on the one or more passengers.

Also in an exemplary embodiment, the system further includes a satellite-based navigation system of the vehicle that is configured to obtain a geographic location of the vehicle; wherein the processor is configured to determine the optimized tint level further based at least in part on a maximum tinting value based a regulatory limit associated with the geographic location.

Also in an exemplary embodiment, the system further includes a transceiver of the vehicle, the transceiver configured to obtain, from a remote service provider that is remote from the vehicle, via a wireless communications network, ambient weather conditions surrounding the vehicle, including a relative position of the sun with respect to the vehicle and cloud cover with respect to the sun; wherein the processor is configured to determine the optimized tint level further based at least in part on the ambient weather conditions surrounding the vehicle, including the relative position of the sun with respect to the vehicle and cloud cover with respect to the sun.

Also in an exemplary embodiment, the sensor data further pertains to operational parameters as to movement of the vehicle; and the processor is further configured to at least facilitate determining, based on the operational parameters, one or more maneuvers of the vehicle including a vehicle turn; and determining the optimized tint level further based at least in part on the one more maneuvers including the vehicle turn.

Also in an exemplary embodiment, the processor is further configured to at least facilitate determining, using the sensor data, when the vehicle is approaching a known location or situation in which enhanced visibility is required; and determining the optimized tint level in a manner that further provides for reduced tinting via the processor when it is determined by the processor that the vehicle is approaching the known location or situation in which enhanced visibility is required.

In another exemplary embodiment, a vehicle is provided that includes a body, a propulsion system, windows, one or more sensors, and a processor. The propulsion system is disposed within the body, and is configured to move the vehicle. The windows are disposed on the body. The one or more sensors are configured to obtain sensor data pertaining to an age of one or more passengers of the vehicle, the age including whether the one or more passengers include infants, children, or adults; a location of the one or more passengers, including specific passenger seats occupied by the one or more passengers; an activity of the one or more passengers, including a specific type of the activity and whether or not sunlight is beneficial or detrimental to the specific type of activity; and an exposure level of sunlight through the windows on the one or more passengers. The processor is s coupled to the one or more sensors, and is configured to at least facilitate determining an optimized tint level for the windows, based at least in part on each of the following: the age of the one or more passengers, including whether the one or more passengers include infants, children, or adults; the location of the one or more passengers, including the specific passenger seats occupied by the one or more passengers; the exposure level of sunlight through the windows on the one or more passengers; and automatically tinting the windows based on the optimized tint level, in accordance with instructions provided by the processor.

Also in an exemplary embodiment, the sensor data further pertains to operational parameters as to movement of the vehicle; and the processor is further configured to at least facilitate determining, based on the operational parameters, one or more maneuvers of the vehicle including a vehicle turn; determining, using the sensor data, when the vehicle is approaching a known location or situation in which enhanced visibility is required; and determining the optimized tint level further based at least in part on both of the following: the one more maneuvers including the vehicle turn; and whether the vehicle is approaching the known location or situation in which enhanced visibility is required.

Also in an exemplary embodiment, the windows include a plurality of windows, each window of the plurality of windows including a plurality of regions; and the processor is further configured to determine the optimized tint level for each of the plurality of regions of each of the plurality of windows in accordance with the following equation:
Tint (Window)=Area (PA)×∫[αA+βU_{pref}+σ orientation], in which integration of the equation is performed from a minimum value of zero to a maximum regulated value of a geographic location in which the vehicle is location, and in which:
“Area” represents an area of the window, represented by zeros and ones, wherein a zero value represents 100% tinting and a zero value represents 0% tinting;
“PA” represents the activity of the one or more passengers;
“A” represents ambient light inside the vehicle;
“U_{pref}” represents user preferences of the one or more passengers;
“orientation” represents a measure of sun load based on an orientation of the vehicle with respect to the sun; and
“α”, “β”, and “σ” represent weighting factors.

### DESCRIPTION OF THE DRAWINGS

The present disclosure will hereinafter be described in conjunction with the following drawing figures, wherein like numerals denote like elements, and wherein:

FIG. 1 is a functional block diagram of a system, including a vehicle with windows, that is configured for controlling tinting of the windows of the vehicle, in accordance with an exemplary embodiment;

FIG. 2 is a functional block diagram of components of an implementation of a control system of the vehicle of FIG. 1, in accordance with an exemplary embodiment;

FIG. 3 is a flowchart of a process for controlling tinting of a vehicle, and that can be implemented in connection with the system of FIG. 1 and the components thereof including the implementation of FIG. 2, in accordance with an exemplary embodiment; and

FIG. 4 is flow diagram of an exemplary implementation of a subprocess of the process of FIG. 3, including automatically tinting the windows of the vehicle based on passengers and passenger activities within the vehicle, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

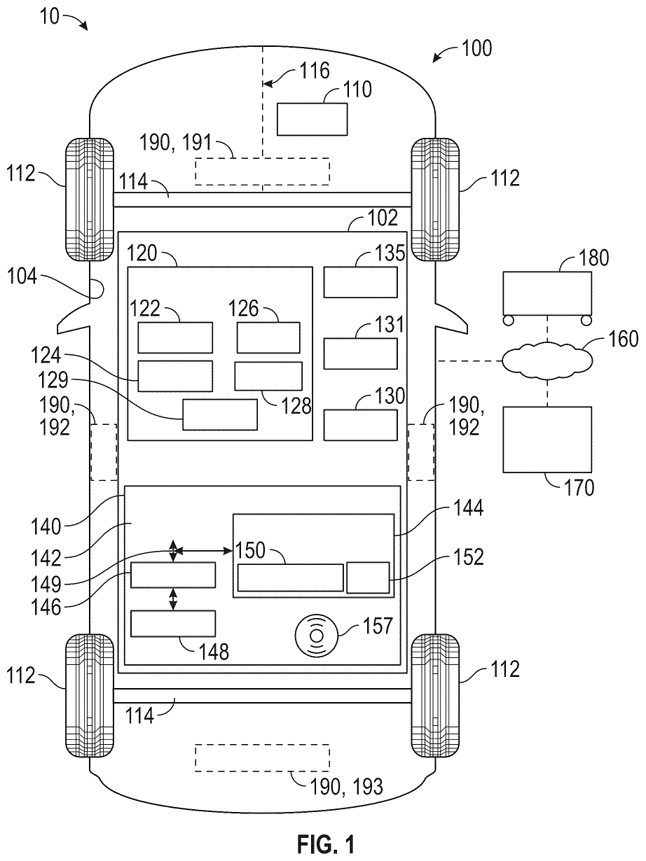

FIG. 1 illustrates a system 10. In various embodiments, and as described below, the system 10 includes a vehicle 100 having windows 190. As described in greater detail below, the system 10 provides for proactive tinting of the windows 190 of the vehicle 100 in accordance with various embodiments, including via instructions provided by a control system 102 of the vehicle 100.

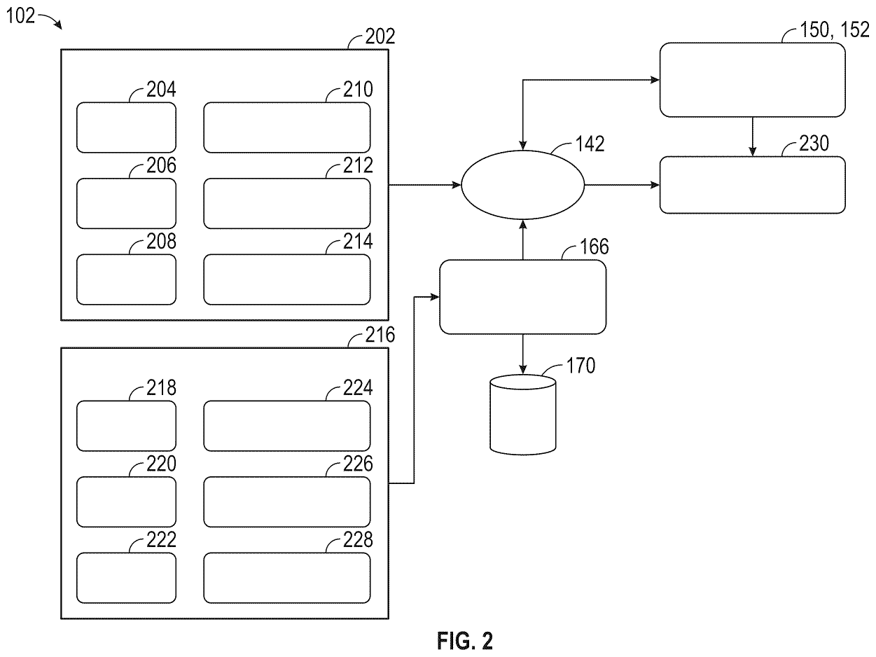

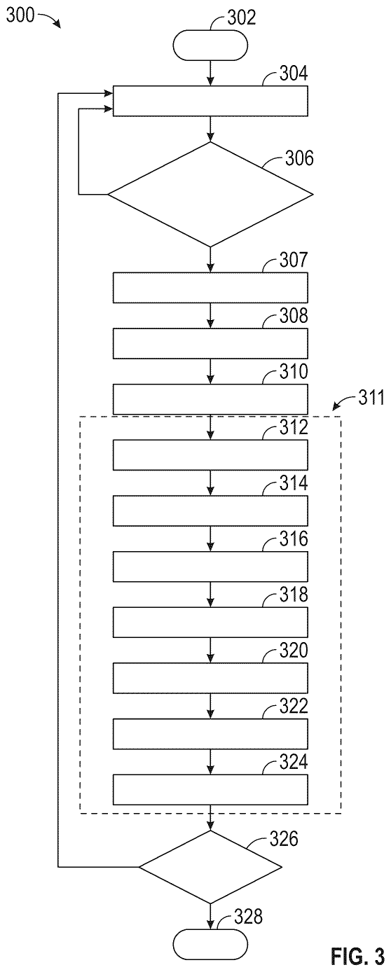

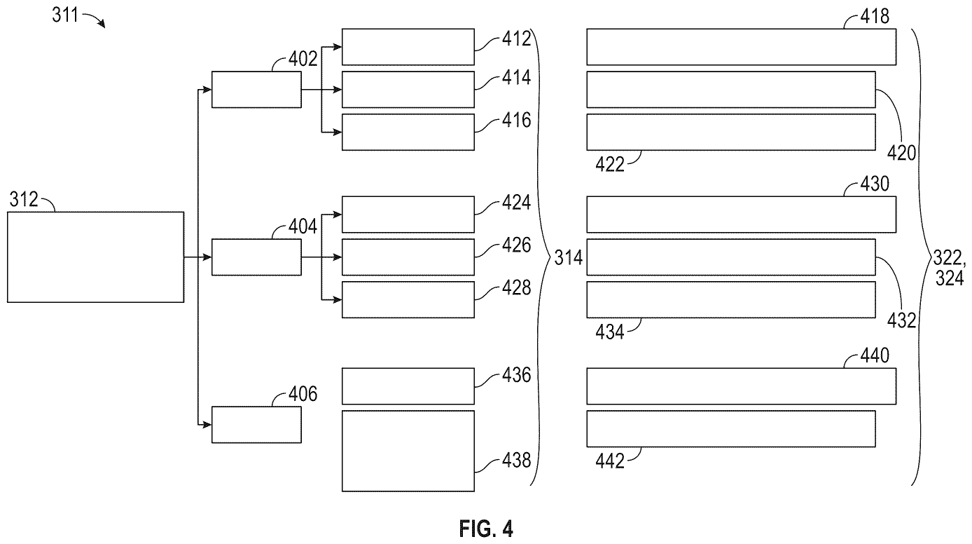

In various embodiments, the system 10 (including the control system 102 of the vehicle 100 thereof) performs these tasks in accordance with the components of the system 10 as detailed below in connection with FIG. 1 as well as the control system 102 implementation of FIG. 2 and the process 300 of FIGS. 3 and 4, and as described in greater detail further below in connection therewith.

Also as depicted in FIG. 1, in various embodiments, the system 10 also includes a communications network 160 and a remote server 170. In certain embodiments, the vehicle 100 depicted is represented as a representative vehicle of a fleet of vehicles 100, and/or the system 10 also includes one or more other vehicles 180. However, this may vary in other embodiments.

In various embodiments, the vehicle 100 comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, such as aircraft, spacecraft, watercraft, and so on, and/or one or more other types of mobile platforms.

In the depicted embodiment, the vehicle 100 includes a body 104 that is arranged on a chassis 116. The body 104 substantially encloses other components of the vehicle 100. The body 104 and the chassis 116 may jointly form a frame. The vehicle 100 also includes a drive system 110 and a plurality of wheels 112. In various embodiments, the drive system 110 is mounted on the chassis 116, and drives the wheels 112, for example via axles 114, to cause movement and propulsion of the vehicle 100.

Also as depicted in FIG. 1, various windows 190 are disposed or formed within or proximate the body 104. In certain embodiments, the windows 190 include a front windshield 190, side windows 192, and a rear window 193. In various embodiments, the side windows 192 may include one or more front driver side windows, rear driver side windows, front passenger side windows, rear passenger side windows, and so on.

As alluded to above, in various embodiments the control system 102 controls tinting of the windows 190 in a proactive matter based on various factors, as described in greater detail further below in connection with FIG. 1 as well as in connection with the implementation of FIG. 2 and the process 300 of FIGS. 3 and 4. In various embodiments, the control system 102 controls the tinting of the windows 190 based on information obtained from the vehicle 100 itself (including an identification and location of passengers and their activities, along with a vehicle location and vehicle actions and an exposure of sunlight via the windows 190 onto the passengers) as well as information obtained in certain embodiments via the communications network 160 from one or more remote servers 170 (e.g., a weather surface and/or other information service) and/or other vehicles 180 (e.g., via vehicle-to-vehicle communications).

As depicted in FIG. 1, in various embodiments, the control system 102 includes a sensor array 120, a display 130, a transceiver 135, a location system 137, and a controller 140.

In various embodiments, the sensor array 120 obtains sensor data pertaining to the vehicle 100, including pertaining to its passengers and their location and activities, as well as pertaining to an ambient environment for the vehicle 100 in addition to conditions of and actions performed by the vehicle 100. In various embodiments, the sensor array 120 includes one or more exterior sensors 122, interior sensors 124, input sensors 126, and vehicle sensors 128. In certain embodiments, the sensor array 120 may also include other sensors 129.

In various embodiments, the exterior sensors 122 obtain sensor data as to an environment surrounding the vehicle 100. In certain embodiments, the exterior sensors 122 include exterior cameras, exterior temperature sensors, and/or one or more other sensors that detect ambient conditions outside a passenger cabin of the vehicle 100, such as a relative position of the sun with respect to the vehicle 100 (and the windows 190 thereof), temperature and other weather conditions, other vehicles and/or other objects in proximity to the vehicle 100, and so on.

In various embodiments, the interior sensors 124 obtain sensor data as to conditions inside the vehicle 100. In certain embodiments, the interior sensors 124 include interior cameras, exterior temperature sensors, and/or one or more other sensors that detect passengers inside the passenger cabin (including location and type of passengers as well as activities undertaken by the passengers), relative position of the passengers with respect to sunlight entering the vehicle 100, temperature and light intensity values within the passenger cabin, and so on.

In various embodiments, the input sensors 126 detect one or more preferences, instructions, and/or other inputs of the passengers, such as an identification of the passengers and/or their activities, preferences as to window tinting for the passengers, a destination and/or route of travel of the vehicle 100, and so on.

In various embodiments, the vehicle sensors 128 measure values of vehicle parameters, including pertaining to operation and movement of the vehicle 100, including position, velocity, acceleration, steering angle, yaw values, other potential indications of vehicle actions (such as accelerating, decelerating, stopping, turning, and the like), and so on.

In various embodiments the sensor array 120 may also include one or more other sensors 129. In certain embodiments, the other sensors 129 may include additional sensors that are able to likewise obtain information regarding the vehicle, passengers within the vehicle, and/or vehicle actions and/or surroundings. For example, in certain embodiments, the other sensors 129 may include one or more turn signal indicator sensors, infrared sensors, biosensors, sonar sensor, radar sensors, Lidar sensors, or the like.

With continued reference to FIG. 1, in various embodiments the display 130 includes one or more devices and/or systems that provide information for the passengers of the vehicle, such as to window tinting and passenger preferences therefor. In certain embodiments, the display 130 includes a display screen, a pop-up display, and/or other visual display that is configured to provide a visual notification for the passengers. In certain other embodiments, the display 130 may include one or more other components, such as an audio component (e.g., including one or more speakers) and/or one or more haptic components (e.g., such as vibrating a passenger seat), and so on.

Also as depicted in FIG. 1, in various embodiments the vehicle 100 also includes a transceiver 135. In various embodiments, the transceiver 135 communicates with the remote servers 170 (e.g., a weather service and/or other information services) and/or other vehicles 180 (e.g., vehicle-to-vehicle communications) via the communications network 160.

Also as depicted in FIG. 1, in various embodiments the vehicle 100 also includes one or more location systems 137. In various embodiments, the location systems 137 comprise one or more satellite-based location systems, such as a global positioning system (GPS). In certain embodiments, the location system 137 is part of a navigation system for the vehicle 100.

In various embodiments, the controller 140 comprises a computer system, and includes a processor 142, a memory 144, an interface 146, a storage device 148, and a computer bus 149. In various embodiments, the controller (or computer system) 140 obtains sensor data from the sensor array 120, and in certain embodiments additional data via the transceiver 135 (e.g., from the remote servers 170 and/or other vehicles 180), including as to the vehicle 100, its occupants, and its surroundings and ambient conditions. In various embodiments, the controller 140 processes the data and utilizes the processed data for controlling tinting of the windows 190 of the vehicle 100. In various embodiments, the controller 140 provides these and other functions in accordance with the process of FIGS. 3 and 4 and as described further below in connection therewith.

In various embodiments, the controller 140 (and, in certain embodiments, the control system 102 itself) is disposed within the body 104 of the vehicle 100. In one embodiment, the control system 102 is mounted on the chassis 116. In certain embodiments, the controller 140 and/or control system 102 and/or one or more components thereof may be disposed outside the body 104, for example on a remote server, in the cloud, or other device where image processing is performed remotely. In certain embodiments, the controller 140 of the vehicle 100 also performs functions in concert with the remote server 170 and/or other vehicles 180.

It will be appreciated that the controller 140 may otherwise differ from the embodiment depicted in FIG. 1. For example, the controller 140 may be coupled to or may otherwise utilize one or more remote computer systems and/or other control systems, for example as part of one or more of the above-identified vehicle 100 devices and systems.

In the depicted embodiment, the computer system of the controller 140 includes a processor 142, a memory 144, an interface 146, a storage device 148, and a bus 149. The processor 142 performs the computation and control functions of the controller 140, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 150 contained within the memory 144 and, as such, controls the general operation of the controller 140 and the computer system of the controller 140, generally in executing the processes described herein, such as the process of FIGS. 3 and 4 and as described further below in connection therewith.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 150 along with stored values 152 (e.g., including in various embodiments, exemplary threshold values for the process 300 of FIGS. 3 and 4) and/or other values for the processing of the data as set forth in the process 300 of FIGS. 3 and 4 and as described further below in connection therewith in accordance with exemplary embodiments).

The bus 149 serves to transmit programs, data, status and other information or signals between the various components of the computer system of the controller 140. The interface 146 allows communication to the computer system of the controller 140, for example from a system driver and/or another computer system, and can be implemented using any suitable method and apparatus. In one embodiment, the interface 146 obtains the various data from the sensor array 120 and/or from one or more other sources (e.g., from the remote server 170 and/or other vehicles 180). The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including various different types of direct access storage and/or other memory devices. In one exemplary embodiment, the storage device 148 comprises a program product from which memory 144 can receive a program 150 that executes one or more embodiments of the processes and implementations of FIGS. 3 and 4 and as described further below in connection therewith. In another exemplary embodiment, the program product may be directly stored in and/or otherwise accessed by the memory 144 and/or a secondary storage device (e.g., disk 157), such as that referenced below.

The bus 149 can be any suitable physical or logical means of connecting computer systems and components. This includes, but is not limited to, direct hard-wired connections, fiber optics, infrared and wireless bus technologies. During operation, the program 150 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 140 may also otherwise differ from the embodiment depicted in FIG. 1, for example in that the computer system of the controller 140 may be coupled to or may otherwise utilize one or more remote computer systems and/or other control systems.

With continued reference to FIG. 1, in various embodiments the vehicle 100, the remote servers 170, and the other vehicles 180 communicate via one or more communications networks 160. In various embodiments, the communications networks 160 may include one or more wireless communications networks (e.g., satellite-based, cellular, and/or any number of other different types of wireless communications networks).

Also in various embodiments, the remote servers 170 are disposed remote from, or a significant physical distance from, the vehicle 100. In certain embodiments, the remote servers 170 include third party information service providers that provide information as to weather conditions such as sun position and cloud cover, traffic conditions, and the like. In various embodiments, the remote servers include respective transceivers, processors, computer memory, and so, similar to respective features of the control system 102 of the vehicle 100. Also in certain embodiments, the other vehicles 180 also include respective control systems with similar components and feature as the vehicle 100, for example with respective sensor arrays, transceivers, computer systems, and so on.

FIG. 2 is a functional block diagram of components of an implementation of the control system 102 of the vehicle 100 of FIG. 1, in accordance with an exemplary embodiment. As depicted in FIG. 2, in various embodiments the control system 102 receives both onboard inputs 202 as well as offboard inputs 216.

In an exemplary embodiment, the control system 102 receives the onboard inputs 202 via one or more onboard computer vision sensors 204, external cameras 206, interior cameras 208, automated driving system sensors 210, vehicle speed sensors 212, and vehicle acceleration sensors 214 (e.g., in certain embodiments, each corresponding to one or more of the exterior sensors 122, interior sensors 124, vehicle sensors 128, and/or other sensors 129 of the sensor array 120 of FIG. 1).

Also in an exemplary embodiment, the control system 102 receives the offboard inputs 216 via the communications network 160 and the remote servers 170, and including via one or more vehicle to vehicle communications 218 (e.g., via the other vehicles 180 of FIG. 1), Internet Data 220 (e.g., as to road, traffic, and/or ambient conditions, from the remote servers 170 of FIG. 1), dedicated short range communications (DSRC) information 222 (e.g., from the remote servers 170 and/or other vehicles 180 of FIG. 1 via the communications network 160), weather information 224 (e.g., as to temperature, sun location and intensity, cloud cover data, and other weather-related information, including from the remote servers 170 of FIG. 1), location information 226 (e.g., from the location system 137 of FIG. 1, such as a GPS and/or other satellite-based location system), and cellular information 228 (e.g., from the remote servers 170 and/or other vehicles 180 of FIG. 1 via the communications network 160), among other possible information types.

As depicted in FIG. 2, in various embodiments, the onboard inputs 202 and the offboard inputs 216 are provided to an onboard computer, namely the processor 142, for processing. Also as depicted in FIG. 2, the processor 142 determines the tinting levels for the windows using an algorithm and lookup table, corresponding to the program 150 and stored values 152 of FIG. 1 in an exemplary embodiments. In various embodiments, the processor 142 utilizes machine learning via one or more neural network models, including a convolutional neural network model (CNN) in one embodiment. In various embodiments, the processor 142 implements instructions accordingly for the determined tinting levels of the windows for auto-dimming execution 230 as depicted in FIG. 2.

FIG. 3 is a flowchart of a process 300 for controlling tinting of a vehicle, in accordance with an exemplary embodiment. In various embodiments the process 300 can be implemented in connection with the system 10 of FIG. 1 and the components thereof including the vehicle 100 of FIG. 1 and the control system 102 of FIG. 1 and the implementation of FIG. 2.

As depicted in FIG. 3, in various embodiments the process 300 begins at step 302. In various embodiments, the process 300 begins when one or more occupants are in the vehicle 100 and/or when the vehicle 100 is turned on or begins operation.

In various embodiments, data is obtained at step 304. In various embodiments, the data includes data obtained form the various sensors of the sensor array 120 of FIG. 1, as well as from the remote servers 170 and other vehicles 180 of FIG. 1 in certain embodiments. In various embodiments, the data of step 304 includes inputs from one or more passengers (including as to requests for window tinting preferences in certain embodiments), data as to passengers inside the vehicle 100 (including as to passenger type including age, location of the passengers, and activities undertaken by the passengers), data as to sun location and exposure inside the vehicle, temperature, weather, and other ambient conditions, vehicle operational data, and other data such as set forth above in connection with the sensor array 120 of FIG. 1 and onboard inputs 202 and the offboard inputs 216 of FIG. 2.

A determination is made as to whether one or more passengers are disposed in one or more seats of the vehicle (step 306). In various embodiments, this determination is made by the processor 142 of FIG. 1 based on the sensor data of step 304 (including based on one or more internal cameras of the vehicle 100 and/or one or more other vehicle sensors).

In various embodiments, if it is determined that one or more passengers are not disposed in a passenger seat, then the process returns to step 304, as data continues to be detected. Steps 304 and 306 thereafter repeat until a determination is made during an iteration of step 306 that a passenger is disposed within a passenger seat of the vehicle 100.

When a determination is made in an iteration of step 306 that a passenger is disposed within a passenger seat of the vehicle 100, a location is determined (step 307). In various embodiments, determinations are made by the processor 142 as to specification locations of the passengers (including which specific passenger seats are occupied by the different respective passengers) based on the sensor data (e.g., based on camera data and/or other sensor data in various embodiments). In certain embodiments, a location of the vehicle 100 is also determined, such as via the location system 137 of FIG. 1.

Also in various embodiments, ambient conditions are ascertained (step 308). In various embodiments, the processor 142 of FIG. 1 makes determinations regarding ambient conditions surrounding the vehicle 100 based on the data of step 304. In various embodiments, the ambient conditions include weather, temperature, location of the sun, and intensity of the sun against the windows 190 of the vehicle 100, among other possible ambient conditions. In certain embodiments, as part of step 308, the location of sun is determined relative to the vehicle 100 as a function of the geographic location of the vehicle (including latitude and longitude) as well as the time of day and day of the year (e.g., as obtained via the location system 137 and/or one or more cameras and/or other sensors of the sensor array 120 in combination with a look-up table or other stored values 152 of FIG. 1), along with other ambient conditions such as cloud cover (e.g., as determined via data form one or more cameras of the vehicle 100 and/or other vehicles 180 and/or via a weather service via one of the remote servers 170).

In various embodiments, exposure to sunlight is calculated (step 310). In various embodiments, the exposure to the sunlight comprises an exposure of passengers to sunlight entering the vehicle 100 via the windows 190. In various embodiments, the exposure to sunlight is further calculated based on both an interior luminance level and an exterior luminance level, such as measured via respective exterior light sensors and interior light sensors as part of the data of step 304.

In various embodiments, one or more types of passengers inside the vehicle are determined (step 312). Specifically, in various embodiments, the processor 142 determines an approximate age category of each passenger (namely, an adult, child, or infant) based on data from one or more interior cameras and/or other sensors (e.g., biometric sensors) of the sensor array 120 as part of the data of step 304.

In addition, determinations are made as to any activities that are being undertaken by the passengers inside the vehicle (step 314). In various embodiments, the processor 142 determines, using the camera data (or in certain embodiments other sensor data) of step 304, whether the passengers are engaged in one or more specific types of activities including but not limited to sleeping, reading, reading a book, on a screen (e.g., a display screen of the vehicle 100 and/or a smart phone or other electronic device of the passenger), playing with a toy, and so on. In various embodiments, determinations are further made as to the a specific type of the activity, and whether or not sunlight is beneficial or detrimental to the specific type of activity (e.g., as sunlight may be beneficial for reading but detrimental for sleeping, and so on).

In certain embodiments, determinations are also made as to any inputs provided by the passengers (step 316). In various embodiments, the processor 142 determines, using the data of step 304 (such as from an input sensor 126 and/or the location system 137 of FIG. 1) passenger inputs as to a destination and/or route of travel of the vehicle 100, activities of the passengers (e.g., as inputted by the passengers), and/or user preferences as to the tinting levels for the windows 190.

Also in various embodiments, determinations are also made as to operation of the vehicle 100 and any ongoing or planned vehicle actions (step 318). In various embodiments, the processor 142 determines, using the data of step 304 (such as from the vehicle sensors 128 of FIG. 1) as to position, velocity, and acceleration values for the vehicle 100, as well as to current, impending, or planned vehicle actions such as decelerating, stopping, turning, and so on.

Also in various embodiments, determinations are also made as to particular regions of the windows 190 (step 320). In various embodiments, the processor 142 determines, using the data of step 304 (such as from the vehicle sensors 128 and/or from stored values 152 of FIG. 1) as to different regions of each of the windows 190 that might warrant a different level of tinting as compared with other regions of the windows 190. For example, in certain embodiments, legal and/or regulatory requirements (i.e., stored in the memory 144 as stored values 152 thereof) may prohibit tinting of certain regions of certain windows 190 (e.g., the front windshield and/or side windows 192 in proximity to the driver) for visibility purposes. By way of additional example, in certain embodiments, the passenger sunlight exposure may be occurring from sunlight entering through certain specific regions of the windows 190.

In various embodiments, tinting levels are determined (step 322). Specifically, in various embodiments, the processor 142 determines optimal tinting levels for each of the regions of each of the windows 190 separately based on the data of step 304 and the various determinations of steps 306-320. For example, in various embodiments, the optimal tinting levels are determined based on the ambient conditions, sunlight exposure of the passengers, the types of passengers (e.g., infant, child, or adult), the specific type(s) of activities of the passengers (e.g., sleeping, reading, on a screen such as a computer screen, playing with a toy, and so on) and whether sunlight is beneficial or detrimental thereto, vehicle operating parameters (e.g., position, velocity, and acceleration), and vehicle actions (e.g., decelerating, stopping, accelerating, turning, and so on).

In certain embodiments, the determining of the optimal level of tinting for each region of each window 190 is determined by the processor 142 in accordance with the following equation:

Tint (Window)=Area (PA)×∫[αA+βU_{pref}+σ orientation] (Equation 1),

in which the integration is performed from a minimum value of zero to a maximum regulated value (e.g., in accordance with applicable legal and/or other regulatory values based on a current geographic location of the vehicle 100, which in various embodiments may be obtained via the memory 144 of the vehicle 100 in certain embodiments, and/or from the remote servers 170 and/or other services in certain other embodiments), and in which:
“Area” represents the window area (represented by zeros and one, wherein a zero value represents 100% tinting and zero represents 0% tinting);
“PA” represents passenger activity;
“A” represents ambient light inside the vehicle 100;
“U_{pref}” represents user preferences of the passengers;
“orientation” represents a measure of sun load based on the vehicle 100 orientation with respect to the sun; and
“α”, “β”, and “σ” represent weighting factors.

In various embodiments, the determined levels of tinting are then applied for the different regions of the windows 190 in accordance with instructions provided by the processor 142 (step 324).

In various embodiments, a determination is made as to whether the vehicle usage is complete (step 326). In certain embodiments, the processor 142 determines whether a current vehicle drive is complete, for example based on a comparison of the current geographic location of the vehicle 100 with an intended destination of the vehicle 100, and/or based on when the vehicle 100 is turned off, or the like.

In various embodiments, if the vehicle usage (e.g., the current vehicle drive) is not yet complete, then the process 300 returns to step 304, as additional data is obtained and steps 304-326 are performed in a new iteration. In various embodiments, once a determination is made in an iteration of step 326 that the vehicle usage is complete, then the process 300 terminates at 328.

As depicted in FIG. 3, in accordance with an exemplary embodiment, steps 311-324 may collectively be referred to as a subprocess 400, including automatically tinting the windows of the vehicle based on passengers and passenger activities within the vehicle 100.

With reference to FIG. 4, a flowchart is provided for this subprocess 400 of the process 300 of FIG. 3, in accordance with an exemplary embodiment.

As depicted in FIG. 4, in various embodiments the passengers are characterized in step 312. As described in greater detail above, in various embodiments the passengers are categorized into three distinct groups, namely: (i) adults 402 (i.e., greater than a first predetermined age threshold); (ii) children 404 (i.e., less than the first predetermined threshold but greater than a second predetermined threshold); and (iii) infants 406 (i.e., less than both the first and second predetermined thresholds).

In various embodiments, determinations are then made as to activities in which the passengers are undertaking (i.e., corresponding to step 314 of FIG. 3), as well as corresponding automatic window tinting (i.e., corresponding to steps 322 and 324 of FIG. 3) based on the passenger type and activity. In various embodiments, the automatic window tinting is applied differently based on the passenger type and activity (and combination thereof), for example as illustrated in FIG. 4 and as described below in connection with exemplary embodiments.

In various embodiments, when the determination is made that the passenger is an adult 402, then a determination is made as to whether the adult passenger is engaging in any of the following activities: (i) sleeping (at 412), (ii) reading a book (at 414), or on a screen (at 416).

In various embodiments, if the adult passenger is determined to be sleeping at 412, then tinting is applied at 418 is applied with a darkest allowable tinting (or in certain embodiments a preferred level of tinting for sleeping per user input settings) up to a predetermined maximum threshold for tinting (for example as determined by law, regulation, or user inputs in certain embodiments).

Also in various embodiments, if the adult passenger is instead determined to be reading a book at 414, then tinting is applied at 420 with tint zones sufficient to block sunlight up to the maximum threshold for tinting for the zones of the window 190 through which the sunlight is directly contacting the body of the adult passenger, while also keeping enough light on or around the book (i.e., so that the adult passenger can still read the book).

Also in various embodiments, if the adult is instead determined to be on a screen at 416, then tinting is applied at 422 with tint zones sufficient to block sunlight up to the maximum threshold for tinting for the zones of the window 190 through which the sunlight is directly contacting the body of the adult passenger, while also keeping enough light on or around the screen while also optimizing the light on the screen for maximum contrast in certain embodiments (i.e., so that the adult passenger can easily view the screen).

Also in various embodiments, when the determination is made instead that the passenger is a child 404, then a determination is made as to whether the child passenger is engaging in any of the following activities: (i) sleeping (at 424), (ii) reading a book (at 426), or on a screen (at 428).

In various embodiments, if the child passenger is determined to be sleeping at 424, then tinting is applied at 430 is applied with a darkest allowable tinting (or in certain embodiments a preferred level of tinting for sleeping per user input settings) up to a predetermined maximum threshold for tinting (for example as determined by law, regulation, or user inputs in certain embodiments).

Also in various embodiments, if the child passenger is instead determined to be reading a book at 426, then tinting is applied at 432 with tint zones sufficient to block sunlight up to the maximum threshold for tinting for the zones of the window 190 through which the sunlight is directly contacting the body of the child passenger, while also keeping enough light on or around the book (i.e., so that the child passenger can still read the book).

Also in various embodiments, if the child passenger is instead determined to be on a screen at 428, then tinting is applied at 434 with tint zones sufficient to block sunlight up to the maximum threshold for tinting for the zones of the window 190 through which the sunlight is directly contacting the body of the passenger, while also keeping enough light on or around the screen while also optimizing the light on the screen for maximum contrast in certain embodiments (i.e., so that the child passenger can easily view the screen).

Also in various embodiments, when the determination is made instead that the passenger is an infant 406, then a determination is made as to whether the infant passenger is engaging in any of the following activities: (i) sleeping (at 436) or (ii) awake and/or playing with a toy (at 438).

In various embodiments, if the infant passenger is determined to be sleeping at 436, then tinting is applied at 440 is applied with a darkest allowable tinting (or in certain embodiments a preferred level of tinting for sleeping per user input settings) up to a predetermined maximum threshold for tinting (for example as determined by law, regulation, or user inputs in certain embodiments).

Also in various embodiments, if the infant passenger is instead determined to be awake and/or playing with a toy at 438, then tinting is applied at 440 with tint zones sufficient to block sunlight up to the maximum threshold for tinting for the zones of the window 190 through which the sunlight is directly contacting the body of the infant passenger, while also keeping enough light available for the infant passenger (e.g., for the infant passenger to play with a toy, look around, and so on).

In certain embodiments, the automatic tinting options as described above may also vary based on user preferences (e.g., as to a desired amount of light and/or brightness when the passenger is reading a book and/or working on a screen, and so on).

Also in various embodiments, similar to the discussions above, the automatic tinting may be applied by the processor 142 based also on other parameters, including ambient conditions and vehicle actions. For example, if it is determined via the processor 142 that the vehicle 100 is turning or about to enter a turn (e.g., based on sensor data indicating activation of a turn signal indicator, and/or based on the current vehicle 100 location in combination with navigation route information, or the like), then in various embodiments the processor 142 may provide additional tinting to protect the driver's vision during the turn. By way of continued example, if it is determined that the vehicle 100 is making or about to make a left turn, then in various embodiments the processor 142 will provide additional tinting of a left side window 192 during the turn to reduce sunlight in the driver's eyes during the turn, and so on. By way of additional example, the processor 142 may likewise provide additional tinting during the turn on one or more windows 190 through which additional sunlight exposure will contact the driver and//or other passengers during the turn, and so on. In certain embodiments, such tinting is automatically performed by the processor 142 in advance of and during the vehicle 100 turn.

Also in certain embodiments, other parameters affecting the automatic tinting may further include approaching particular points of interest with specific visibility requirements. For example, in certain embodiments, the tinting may be adjusting appropriately in such situations, including by temporarily reducing tinting, thereby enabling increased visibility, in the following exemplary situations: (i) security gate entry and exit; (ii) tunnel entry and exit; (iii) parking structure entry and exit; (iv) garage entry and exit; (v) child pickup and drop off; (vi) ride sharing pick up and drop off; (vii) tax cabs; (viii) approaching and departing from law enforcement check points; (ix) approaching and departing from international border crossings; (x) crossing state borders (e.g., by modifying window tinting to provide comfort while adhering to state regulations), and so on.

By way of further example, in certain embodiments the automatic tinting provides gradual untinting of all windows 190 when the approaching a destination, such as (i) an identified home, work, or other frequently visited destination; (ii) a navigation destination or other predicted destination based on user inputs or prior trip patterns; or (iii) a parking lot entry, such as when the driver is looking for parking and/or when requesting parking assistance services.

By way of further example, in certain embodiments the automatic tinting provides additional adjustments when the vehicle 100 is in proximity to a law enforcement vehicle and/or officer. In one such embodiment, automatic tint reduction for the windows 190 is applied when a light source is detected via the sensors from a nearby law enforcement vehicle (such as flashlight lights from the law enforcement vehicle and/or a spotlight from the law enforcement vehicle aimed at the vehicle 100). In certain embodiments, automatic tinting is allowed when the law enforcement vehicle is stationary while the vehicle 100 is in motion (i.e., such that the vehicle 100 is travelling past the law enforcement vehicle). Also in certain embodiments, when a law enforcement officer is searching for someone by scanning vehicles using a light, information is received via the vehicle 100 (e.g., using connected services from the remote servers 170 and/or other vehicles 180 of FIG. 1), then the processor 142 proactively reduces the tinting of the windows 190 of the vehicle 100 accordingly. In certain embodiments, tinting is adjusted based on whether the vehicle 100 is approaching a law enforcement vehicle and/or other emergency vehicle based on the circumstances of a situation pertaining thereto, and thus pertaining to the context. For example, if emergency vehicles are on the road pertaining to an event with which the vehicle 100 has not been a part, then in certain embodiments the windows of the vehicle 100 may be tinted (i.e., with a higher level of tint) accordingly so that the lights of the emergency vehicles do not make it uncomfortable for the driver of the vehicle 100 to drive. Conversely, by way of additional example, if a police vehicle pulls over the vehicle 100, then in various embodiments the windows of the vehicle 100 may be un-tinted (i.e., with a lower level of tint).

Also in certain embodiments, the automatic tinting is performed in a manner that provides entertainment, such as for children and infants. For example, in certain embodiments, patterns and/or movement of images, designs, shapes, and/or patterns may be applied as part of the window tinting, including for providing a game for the passengers (such as following the movement of images) and/or other entertainment value (e.g., such as depicting an aesthetically pleasing image or picture, and/or of an animal, toy, cartoon character and/or other recognizable symbol and/or feature), and/or by depicting one or more different colors, and so on.

Also in certain embodiments, the processor 142 saves a profile for the particular passenger (including the type of passenger, preferences, and types of activities pertaining to the passenger, and so on) and stored the profile in the memory 144 as stored values 152 therein for future use, for example, in subsequent vehicle drives when the passenger may change seats.

Also in various embodiments, when the vehicle 100 experiences a vehicle event (e.g., such as contact with another vehicle and/or object), the processor 142 automatically untints all windows 190 (i.e., by reducing tint as much as possible), for example for enhanced visibility for first responders.

Accordingly, methods, systems, and vehicles are provided for controlling tinting of windows of vehicles. In various embodiments, the window tinting is automatically performed via instructions that are provided via a computer processor based on a variety of factors that include passengers detected in the vehicle, identifications as to types, locations, and activities associated with the passengers, along with sunlight exposure, weather and other ambient conditions, vehicle operational data, and vehicle actions.

It will be appreciated that the systems, vehicles, and methods may vary from those depicted in the Figures and described herein. For example, the system 10 of FIG. 1, including the vehicle 100, the control system thereof, and the remote server 170 of FIG. 1 and components thereof, may differ from that depicted in FIG. 1 as well as the exemplary implementation of the control system 102 thereof of FIG. It will similarly be appreciated that the steps of the processes and implementations of FIGS. 3 and 4 may differ from those depicted in the Figures, and/or that various steps may occur concurrently and/or in a different order than that depicted in the Figures.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling dimming of windows of a vehicle, the method comprising:
obtaining, via one or more sensors of the vehicle, sensor data pertaining to an activity of one or more passengers of the vehicle;
determining, via a processor of the vehicle, an optimized tint level for the windows, based at least in part on the activity of the one or more passengers; and
automatically tinting the windows based on the optimized tint level, in accordance with instructions provided by the processor.

2. The method of claim 1, wherein the optimized tint level is automatically adjusted by the processor based at least in part on a specific type of the activity of the one or more passengers and whether or not sunlight is beneficial or detrimental to the specific type of activity.

3. The method of claim 1, wherein:
the sensor data further pertains to a location of the one or more passengers of the vehicle, including specific passenger seats occupied by the one or more passengers; and
the determining of the optimized tint level is further based at least in part on the location of the one or more passengers, including the specific passenger seats occupied by the one or more passengers.

4. The method of claim 1, wherein:
the sensor data further pertains to an age of the one or more passengers of the vehicle, including whether the one or more passengers are categorized as infants, children, or adults; and
the determining of the optimized tint level is further based at least in part on the age of the one or more passengers, including whether the one or more passengers are categorized as infants, children, or adults.

5. The method of claim 1, wherein:
the sensor data further pertains to an exposure level of sunlight through the windows on the one or more passengers; and
the determining of the optimized tint level is further based at least in part on the exposure level of the sunlight through the windows on the one or more passengers.

6. The method of claim 1, further comprising:
obtaining, via a satellite-based navigation system of the vehicle, a geographic location of the vehicle; and
obtaining a maximum tinting value based a regulatory limit associated with the geographic location;
wherein the determining of the optimized tint level is further based at least in part on the maximum tinting value based on the regulatory limit.

7. The method of claim 1, wherein:
the sensor data further pertains to operational parameters as to movement of the vehicle;
the method further comprises determining, via the processor, based on the operational parameters, one or more maneuvers of the vehicle including a vehicle turn; and
the determining of the optimized tint level is further based at least in part on the one more maneuvers including the vehicle turn.

8. The method of claim 1, further comprising:
determining, via the processor using the sensor data, when the vehicle is approaching a known location or situation in which enhanced visibility is required; and
the determining of the optimized tint level further provides for reduced tinting via the processor when it is determined by the processor that the vehicle is approaching the known location or situation in which enhanced visibility is required.

9. A system comprising for controlling dimming of windows of a vehicle, the system comprising:
one or more sensors of the vehicle, the one or more sensors configured to obtain sensor data pertaining to an activity of one or more passengers of the vehicle; and
a processor that is coupled to the one or more sensors and that is configured to at least facilitate:
determining an optimized tint level for the windows, based at least in part on the activity of the one or more passengers; and
automatically tinting the windows based on the optimized tint level, in accordance with instructions provided by the processor.

10. The system of claim 9, wherein the processor is configured to automatically adjust the optimized tint level based at least in part on a specific type of the activity of the one or more passengers and whether or not sunlight is beneficial or detrimental to the specific type of activity.

11. The system of claim 9, wherein:
the sensor data further pertains to a location of the one or more passengers of the vehicle, including specific passenger seats occupied by the one or more passengers; and
the processor is configured to determine the optimized tint level further based at least in part on the location of the one or more passengers, including the specific passenger seats occupied by the one or more passengers.

12. The system of claim 9, wherein:
the sensor data further pertains to an age of the one or more passengers of the vehicle, including whether the one or more passengers are categorized as infants, children, or adults; and
the processor is configured to determine the optimized tint level further based at least in part on the age of the one or more passengers, including whether the one or more passengers are categorized as infants, children, or adults.

13. The system of claim 9, wherein:
the sensor data further pertains to an exposure level of sunlight through the windows on the one or more passengers; and
the processor is configured to determine the optimized tint level further based at least in part on the exposure level of the sunlight through the windows on the one or more passengers.

14. The system of claim 9, further comprising:
a satellite-based navigation system of the vehicle that is configured to obtain a geographic location of the vehicle;
wherein the processor is configured to determine the optimized tint level further based at least in part on a maximum tinting value based a regulatory limit associated with the geographic location.

15. The system of claim 9, further comprising:
a transceiver of the vehicle, the transceiver configured to obtain, from a remote service provider that is remote from the vehicle, via a wireless communications network, ambient weather conditions surrounding the vehicle, including a relative position of the sun with respect to the vehicle and cloud cover with respect to the sun;
wherein the processor is configured to determine the optimized tint level further based at least in part on the ambient weather conditions surrounding the vehicle, including the relative position of the sun with respect to the vehicle and cloud cover with respect to the sun.

16. The system of claim 9, wherein:
the sensor data further pertains to operational parameters as to movement of the vehicle; and
the processor is further configured to at least facilitate:
determining, based on the operational parameters, one or more maneuvers of the vehicle including a vehicle turn;
determining the optimized tint level further based at least in part on the one more maneuvers including the vehicle turn.

17. The system of claim 9, wherein the processor is further configured to at least facilitate:
determining, using the sensor data, when the vehicle is approaching a known location or situation in which enhanced visibility is required; and
determining the optimized tint level in a manner that further provides for reduced tinting via the processor when it is determined by the processor that the vehicle is approaching the known location or situation in which enhanced visibility is required.

18. A vehicle comprising:
a body;
a propulsion system disposed within the body and configured to move the vehicle;
windows disposed on the body;
one or more sensors configured to obtain sensor data pertaining to:
an age of one or more passengers of the vehicle, the age including whether the one or more passengers comprise infants, children, or adults;
a location of the one or more passengers, including specific passenger seats occupied by the one or more passengers;
an activity of the one or more passengers, including a specific type of the activity and whether or not sunlight is beneficial or detrimental to the specific type of activity; and
an exposure level of sunlight through the windows on the one or more passengers; and
a processor that is coupled to the one or more sensors and that is configured to at least facilitate:
determining an optimized tint level for the windows, based at least in part on each of the following:
the age of the one or more passengers, including whether the one or more passengers comprise infants, children, or adults;
the location of the one or more passengers, including the specific passenger seats occupied by the one or more passengers;
a specific type of the activity of the one or more passengers and whether or not sunlight is beneficial or detrimental to the specific type of activity; and
the exposure level of sunlight through the windows on the one or more passengers; and
automatically tinting the windows based on the optimized tint level, in accordance with instructions provided by the processor.

19. The vehicle of claim 18, wherein:
the sensor data further pertains to operational parameters as to movement of the vehicle; the processor is further configured to at least facilitate:
determining, based on the operational parameters, one or more maneuvers of the vehicle including a vehicle turn;
determining, using the sensor data, when the vehicle is approaching a known location or situation in which enhanced visibility is required; and
determining the optimized tint level further based at least in part on both of the following:
the one more maneuvers including the vehicle turn; and
whether the vehicle is approaching the known location or situation in which enhanced visibility is required.

20. The vehicle of claim 18, wherein:
the windows comprise a plurality of windows, each window of the plurality of windows including a plurality of regions; and
the processor is further configured to determine the optimized tint level for each of the plurality of regions of each of the plurality of windows in accordance with the following equation:
Tint (Window)=Area (PA)×∫[αA+βU_{pref} +σ orientation],
in which integration of the equation is performed from a minimum value of zero to a maximum regulated value of a geographic location in which the vehicle is location, and in which:
“Area” represents an area of the window, represented by zeros and ones, wherein a zero value represents 100% tinting and a zero value represents 0% tinting;
“PA” represents the activity of the one or more passengers;
“A” represents ambient light inside the vehicle;
“U_{pref}” represents user preferences of the one or more passengers;
“orientation” represents a measure of sun load based on an orientation of the vehicle with respect to the sun; and
“α”, “β”, and “σ” represent weighting factors.
